(19) United States
(12) Patent Application Publication
(10) Pub. No.: US 2017/0359967 A1
(43) Pub. Date: Dec. 21, 2017

(54) TEXTILE BARRIER INCLUDING AQUEOUS SUPER ABSORBENT POLYMER COMPOSITION

(71) Applicant: SAPGEO LLC, Alparetta, GA (US)

(72) Inventors: Christopher Tetrault, Amelia, OH (US); Michael R Ayers, Alpharetta, GA (US); Jacob Tetrault, Alpharetta, GA (US)

(21) Appl. No.: 15/532,554

(22) PCT Filed: Dec. 4, 2015
(86) PCT No.: PCT/US2015/064123

§ 371 Date: Jun. 2, 2017

Related U.S. Application Data
(60) Provisional application No. 62/123,990, filed on Dec. 4, 2014.

(51) Int. Cl. A01G 13/02; A41D 1/04; A41B 11/14; A41B 17/00; A41D 1/02; A42B 3/10; A42B 1/00; A41F 3/00; B65D 81/26; A41D 31/00; A41D 27/04; A41D 27/02; A41D 23/00; A41D 13/04; A41D 13/02; A41D 13/00; A41D 1/06; A01M 21/04; A43B 7/00; A01G 9/14; E04B 1/62; E04D 5/10; E04B 1/94

(52) U.S. Cl. CPC A01G 13/0268; A43B 7/005; A41D 1/04; A41B 11/14; A41B 17/00; A41D 1/02; A42B 3/10; A42B 1/008; A41F 3/00; B65D 81/264; A41D 31/0016; A41D 27/04; A41D 27/02; A41D 23/00; A41D 13/04; A41D 13/02; A41D 13/0002; A41D 1/06; A01M 21/043; A01G 2009/1453; A41D 2023/002; E04B 1/625; A01G 9/1438; E04D 5/10; E04B 1/94

(57) ABSTRACT

A textile barrier apparatus includes an inner layer comprising an aqueous super absorbent polymer composition (SAP) and first and second outer textile layers attached to opposite sides of the inner layer. A landfill version includes an odor neutralizer, a biocide and/or a nutrient to support vegetation. A fire barrier version has the first and second outer textile layers including water permeable membrane and a fire retardant treatment. A planting groundcover version includes a patterned thickness of SAP corresponding to a planting pattern and a nutrient to support vegetation.

### CLAIM OF PRIORITY UNDER 35 U.S.C. §119

The present Application for Patent claims priority to Provisional Application No. 62/123,990 entitled “AQUEOUS SUPER ABSORBENT POLYMER COMPOSITIONS AND METHODS OF USE” filed 4 Dec. 2014, and assigned to the assignee hereof and hereby expressly incorporated by reference herein.

### FIELD OF THE INVENTION

The present disclosure generally relates to aqueous super absorbent polymer compositions, and more particularly to forming a water-absorbent textile barrier compositions.

### BACKGROUND OF THE INVENTION

Super absorbent polymers are known in the art and described in Anderson et al. U.S. Pat. No. 6,686,414; U.S. Pat. No. 6,984,419; and U.S. Pat. No. 7,438,951; and in Chang et al. U.S. Pat. No. 4,914,170, the disclosures of which are hereby incorporated by reference in their entirety. A super absorbent polymer (also referred to as a SAP) absorbs large quantities of water as well as other fluids. A super absorbent polymer is typically designed to have variable resistance to humidity, but will swell when put in intimate contact with water.

A super absorbent polymer is usually prepared by one of two methods. The first method involves sufficiently crosslinking emulsion or aqueous solution polymers to make the polymers water insoluble, while retaining their ability to swell in water. The second method is directed at effectively modifying water-insoluble polymers with hydrophilic groups to induce swelling when the polymers are in contact with water.

Super absorbent polymers find application in the medical, food and agricultural industries. These polymers also find utility in many consumer products, in particular disposable absorbent articles such as disposable diapers, incontinent pads and feminine care products. The ability to provide thinner, more compact absorbent articles has been contingent on the ability to develop relatively thin absorbent cores that can acquire, distribute and store large quantities of fluid, particularly urine. As a result, super absorbent polymers are being developed with a higher capacity to absorb large quantities of fluids, especially water.

Super absorbent polymers are available in a particulate, fibrous, granular or powder form. In the case of diaper construction, super absorbent polymers are sifted into the absorbent core. The absorbent core is sandwiched between a fluid pervious top sheet and a fluid impervious back sheet. The incorporation of particulate super absorbent polymers tends to generate dust from the super absorbent polymer fines. Further, conventional absorbent articles have the limitation of the super absorbent polymer not being sufficiently immobilized and thus free to migrate and shift during the manufacturing process, shipping/handling and/or use. Movement of the super absorbent polymer particles during manufacture can lead to handling losses as well as improper distribution of the particles.

Further, absorbency problems occur when the super absorbent polymer particles migrate prior to, during or after swelling. This inability to fix the particles at optimum locations leads to insufficient fluid storage in one area and over capacity in other areas. Another important factor is the liquid permeability of the super absorbent polymer. The fluid transport properties of the gel layer formed as a result of the swelling super absorbent polymer particles in the presence of fluids are extremely important. Although the formation of a super absorbent polymer gel layer fluid barrier (known as “gel blocking”) is desirable for some applications, such as for use in cables, the formation of a gel layer in disposable absorbent products is undesirable since the gel layer greatly reduces the efficiency of the super absorbent polymer. Thus, the advantages of being able to fixate super absorbent polymer particles in place are apparent and several ways of accomplishing that have been suggested.

There are patents that disclose crosslinkable, water soluble/swellable polyacrylate based compositions. However, while commercially available super absorbent polymers tend to be in granular, fibrous, particulate or powdered form, the focus of the prior art is making highly viscous emulsions and dispersions that are subsequently dried, masticated, pulverized or ground to the desired size.

As industry recognized the deficiencies of a particulate super absorbent polymer, aqueous based super absorbent polymer compositions began to be developed, such as Cheng et al. U.S. Pat. No. 5,693,707, the disclosures of which is hereby incorporated by reference in its entirety. Cheng teaches an aqueous polymer composition comprising 10 to 40% of a polymer in water, the polymer consisting essentially of 20-90 weight percent of an alpha, beta-ethylenically unsaturated carboxylic acid monomer, at least one softening monomer, the aqueous composition being adjusted to pH 4-6 with an alkali metal hydroxide or an alkaline earth metal hydroxide.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 illustrates an isotropic diagram multi-use textile barrier apparatus incorporating an aqueous super absorbent polymer (SAP) composition layer, according to one or more embodiments;

FIG. 1A illustrates a cross sectional diagram of the multi-use textile barrier apparatus of FIG. 1 with an unwetted SAP composition layer, according to one or more embodiments;

FIG. 1B illustrates a cross sectional diagram of the multi-use textile barrier apparatus of FIG. 1 with a wetted SAP composition layer, according to one or more embodiments;

FIG. 2 illustrates a cross sectional diagram of a first example textile barrier apparatus that includes an odor mitigating additive for use as a landfill cover/blanket, according to one or more embodiments;

FIG. 3 illustrates a cross sectional diagram of a second example textile barrier apparatus for use as a fire barrier textile for structure protection, according to one or more embodiments;

FIG. 4 illustrates a cross sectional diagram of a third example textile barrier apparatus for use as a vegetation support ground cover textile, according to one or more embodiments;

FIG. 5 illustrates a cross sectional diagram of another example textile barrier apparatus for use as a vegetation support ground cover textile, according to one or more embodiments; and

FIG. 6 illustrates a cross sectional diagram of a fourth example textile barrier apparatus for use as self-healing membrane, according to one or more embodiments.

### DETAILED DESCRIPTION

Briefly described, the present innovation is directed to aqueous super absorbent polymer compositions having an ability to absorb moisture, particularly water. This moisture absorbing feature renders the compositions of the present innovation useful and effective in many applications.

Examples of the applications for the aqueous super absorbent polymer compositions of the present innovation include a landfill cover/blanket with odor control, a fire barrier textile for structure protection, a hydro blanket fire barrier for control of forest type fires, a vegetation support ground cover textile, a self-healing membrane and a coated sand product.

The aqueous super absorbent polymer compositions of the present innovation can also contain a super absorbent polymer, which is in particulate form.

The aqueous super absorbent polymer compositions of the present invention comprise a soluble polymer, a crosslinking agent and water.

Depending on the desired final composition, additional components can be used in these compositions, examples of which are dispersants, pH modifiers, binders, surfactants, stabilizers and nutrients. For example, these components can be used in amounts of from 1-20 percent by weight, (based on the weight of the super absorbent polymer(s) in the final composition), preferably from 5-15 percent by weight or more preferably from 5-10 percent by weight, based on the weight of the super absorbent polymer(s) in the final composition.

As used in the present specification, the following words and phrases are generally intended to have the meanings set forth below, except to the extent that the context in which these words and phrases are used indicates otherwise.

The term “binder” or “binding agent” refers to a material having binding, adhesive or attachment properties with or without chemical, thermal, pressure or other treatment. These terms include materials that are capable of attaching themselves to a substrate or are capable of attaching other substances to a substrate. The binder component used in the coating compositions of the present innovation can include any polymeric material customarily used as a binder in coating compositions.

In one embodiment, the binder is a composition such as water, polyacrylate, lignin sulfonate (solid), polymeric binders, silicone polymer, e.g., polyorganosiloxane and combinations thereof. In another embodiment, the organic polymerizable binders include, but are not limited to, carboxymethylcellulose and its derivatives and its metal salts, guar gum cellulose, xanthan gum, starch, lignin, polyvinyl alcohol, polyacrylic acid, styrene butadiene resins and polystyrene acrylic acid resins.

In one embodiment, the binders are selected from the group consisting of acrylic acid grafted starch, alginates, alkoxysilanes (for example, tetraethoxy silane), block co-polymers, carboxymethyl starch, carboxymethylcellulose, carrageenan gum, casein, cellulose acetate phthalate, cellulose based polymers, cellulose derivatives (such as dextrans and starches, gelatin, guar gum cellulose, hydrolyzed acrylonitrile grafted starch and hydroxymethyl cellulose), lignin, locust bean gum, maleic anhydride copolymers, methyl cellulose, monomeric silanes, natural gums, pectins, poly (2-hydroxyethylacrylate), poly (ethylene oxide), poly (sodium acrylate-co-acrylic acid), poly (2-hydroxyethylmethacrylate), poly(acrylamides), poly(acrylates), poly(ethers), poly(methacrylic acid), poly (N-vinyl pyrrolidone), poly(vinyl alcohol), poly(vinyl sulfonates), poly (vinylsulfonic acid), polyesters, polyethylene oxide, polymeric binders, polymers formed from acid-group containing monomers, polyorganosiloxanes, polystyrene acrylic acid resins, polyurethanes, polyvinyl alcohol, polyvinylmethyl ether, polyvinylpyrrolidone, silicates, silicone polymers, starch, starch-based polymers, silanes, organosiloxanes, styrene butadiene resins, xanthan gum and mixtures thereof.

The term “cross-linking” or “cross-linked” used in reference to the super absorbent polymer refers to any means for effectively rendering normally water-soluble materials substantially water-insoluble, but swellable. Such a cross-linking means can include, for example, physical entanglement, crystalline domains, covalent bonds, ionic complexes and associations, hydrophilic associations such as hydrogen bonding, hydrophobic associations or Van der Waals forces. Super absorbent polymers can contain internal cross-linking and surface cross-linking.

The term “polymer” includes, but is not limited to, homopolymers, copolymers, (for example, block, graft, random, and alternating copolymers), terpolymers, etc. and blends and modifications thereof. Furthermore, unless otherwise specifically limited, the term “polymer” shall include all possible configurational isomers of the material. These configurations include, but are not limited to, isotactic, syndiotactic and atactic symmetries.

The term “polymer” as used in this application refers to a series of repeating monomeric units that have been cross-linked or polymerized. Any suitable polymer can be used to carry out the present invention. The polymers of the invention may also comprise two, three, four or more different polymers. In some embodiment, of the invention, only one polymer is used. In some preferred embodiments, a combination of two polymers is used. Combinations of polymers can be in varying ratios to provide coatings with differing properties.

Those of skill in the art of polymer chemistry will be familiar with the different properties of polymeric compounds. Examples of polymers that may be used in the present invention include, but are not limited to, polycarboxylic acids, cellulosic polymers, proteins, polypeptides, polyvinylpyrrolidone, maleic anhydride polymers, polyamides, polyvinyl alcohols, polyethylene oxides, glycosaminoglycans, polysaccharides, polyesters, polyurethanes, polystyrenes, copolymers, silicones, polyorthoesters, polyanhydrides, copolymers of vinyl monomers, polycarbonates, polyethylenes, polypropylenes, polylactic acids, polyglycolic acids, polycaprolactones, polyhydroxybutyrate valerates, polyacrylamides, polyethers, polyurethane dispersions, polyacrylates, acrylic latex dispersions, polyacrylic acid and mixtures and copolymers thereof.

The polymers of the present invention may be natural or synthetic in origin, including gelatin, chitosan, dextrin, cyclodextrin, poly(urethanes), poly(siloxanes) or silicones, poly(acrylates) such as poly(methyl methacrylate), poly(butyl methacrylate), and poly(2-hydroxy ethyl methacrylate), poly(vinyl alcohol), poly(olefins) such as poly (ethylene), poly(isoprene), halogenated polymers such as poly(tetrafluoroethylene) and derivatives and copolymers such as those commonly sold as Teflon products, poly(vinylidine fluoride), poly (vinyl acetate), poly(vinyl pyrrolidone) poly(acrylic acid). polyacrylamide. poly(ethylene-co-vinyl acetate), poly(ethylene glycol), polypropylene glycol) and poly (methacrylic acid).

The term “super absorbent materials” refers to water swellable water-insoluble organic or inorganic materials including super absorbent polymers and super absorbent polymer compositions capable, under the most favorable conditions, of absorbing at least about 1 times their weight, or at least about 5 times their weight, or at least about 10 times their weight in an aqueous solution. Superabsorbent materials include a “super absorbent polymer”, a normally water-soluble polymer which has been cross-linked to render the polymer substantially water insoluble, but capable of absorbing water. Numerous examples of super absorbers and their methods of preparation may be found in U.S. Pat. Nos. 4,102,340; 4,467,012; 4,950,264; 5,147,343; 5,328,935; 5,338,766; 5,372,766; 5,849,816; 5,859,077; and U.S. Reissue Pat. No. 32,649, the disclosures of which are hereby incorporated by reference in their entirety.

Super absorbent polymers generally fall into three classes, namely starch graft copolymers, cross-linked carboxymethylcellulose derivatives and modified hydrophilic polyacrylates Non-limiting examples of such absorbent polymers are hydrolyzed starch acrylate graft co-polymers, saponified acrylic acid ester-vinyl co-polymers, neutralized cross-linked polyacrylic acid, cross-linked polyacrylate salts, and carboxylated cellulose. The preferred super absorbent polymers, upon absorbing fluids, form hydrogels. Super absorbent polymers are well known and are commercially available from several sources.

The term “water-absorbing material” as used in this application includes, but is not limited to, a hydrophilic polymer. Water-absorbing materials include, but are not limited to, a highly absorbent material, which may comprise a super absorbent polymer. Examples of water-vapor trapping materials include, but are not limited to, acrylate polymers, generally formed from acrylic acid, methacrylic acid, an acrylate, methyl acrylate, ethyl acrylate, methyl methacrylate, ethyl methacrylate, a dialkylaminoalkyl acrylate, a dialkylaminoalkyl methacrylate, a trialkylammonioalkyl acrylate, and/or a trialkylammonioalkyl methacrylate, and include the polymers or copolymers of acrylic acid, methacrylic acid, methyl methacrylate, ethyl methacrylate, 2-dimethylaminoethyl methacrylate and trimethylanamonioethyl methacrylate chloride. Examples of hydrophilic polymers include, but are not limited to, poly(N-vinyl lactams), poly(N-vinyl acrylamides), poly (N-alkylacrylamides), substituted and unsubstituted polymers of acrylic and methacrylic acid, polyvinyl alcohol, polyvinyl amine, copolymers thereof and copolymers with other types of hydrophilic monomers (e.g., vinyl acetate), polysaccharides, cross-linked amylate polymers and copolymers, carbomers, cross-linked acrylamide-sodium acrylate copolymers, gelatin, vegetable polysaccharides, such as alginates, pectins, carrageenans, or xanthan, starch and starch derivatives, galactomannan and galactomannan derivatives, polyvinyl pyrrolidone, poly(N-vinyl caprolactam), poly(N-vinyl acetamides), polyacrylic acid polymethacrylic acid, and copolymers and blends thereof. Examples of super absorbent polymers include hydrogels. Copolymers of any of the water-vapor trapping materials mentioned in this application, and blends thereof, may also be used.

The term “percent by weight” or “weight percent” when used in this application and referring to components of the super absorbent polymer composition, is to be interpreted as based on the weight of the dry super absorbent polymer composition, unless otherwise specified in this application. These terms may be defined with additional language in the remaining portions of the specification.

Polymerization of the one or more super absorbent polymers may occur via exposure to ultraviolet (UV) light radiation, peroxides, or other known polymerization process. UV-dependent photoinitiators of polymerization useful in exemplary embodiments of the present invention are water soluble or water dispersible compounds that generate free radicals upon exposure to UV radiation. Examples of such polymerization initiators include, 4-benzoyl-N,N-dimethyl-N-(2-(1-oxo-2-propenyloxy)ethyl) benzenemethananaminium bromide in combination with N-methyl-diethanolamine, and 2-hydroxy-2-methyl-1-phenyl-1-propanone.

When the super absorbent polymers are contacted with water, the super absorbent polymers increase dramatically in size. Depending on the relative size and thickness, the super absorbent polymers may reach maximum moisture retention in as quickly as about ten minutes or as much as days. After reaching maximum moisture retention, the retained moisture slowly releases from the super absorbent polymers depending on the particular conditions present, such as for example, ambient temperature, sunlight, humidity, etc.

The present innovation also contemplates the use of small amounts of water insoluble monomers, provided the intended properties of the pre-crosslinked and/or post-crosslinked polymer are not adversely affected.

Any free radical generating source, such as peroxides and persulfates, may be used to initiate the polymerization of the monomers as well known to those skilled in the art. Further, chain transfer agents known in the art may be employed to alter the molecular weight of the super absorbent polymer.

The aqueous composition of the carboxylic acid-containing polymer contains about 5 to about 65 weight percent solids, preferably about 10 to about 50 weight percent solids, and more preferably about 20 to about 40 weight percent solids. When polymerization is essentially complete, the aqueous composition is adjusted to a pH of about 7-10 using an alkali metal hydroxide (such as sodium hydroxide or potassium hydroxide), and/or an alkaline earth metal hydroxide, such as calcium hydroxide. Further, a metal alkoxide can be used.

In the composition of the present innovation, the amount of super absorbent polymer can vary, but is generally in the ratio of polymer: water of up to 1:1.

To produce crosslinking of the polymer through its carboxylic acid functionality and create a super absorbent polymer, a sufficient amount of crosslinking agent is added to the aqueous polymer composition. Suitable crosslinking agents include any substance that will react with the hydrophilic groups of the aqueous solution polymer. The selection and concentration of crosslinking agent will affect the absorbent rate and capacity. Preferably, the crosslinking agent reacts with the functional groups on the polymer in less than 24 hours and at ambient and/or elevated temperatures.

Any of the known crosslinking agents may be employed, such as those described in Ganslow et al. U.S. Pat. No. 4,090,013, the disclosure of which is hereby incorporated by reference in its entirety. The use of zirconium ions, ferric aluminum, chromic ions, titanium ions, zinc ions, aluminum ions and aziridine has been found to be useful as crosslinking agents when used separately or in combination with any one or more of these agents.

The crosslinking agent is added to the aqueous polymer solution at a concentration ranging from about 1 part to about 20 parts, preferably from about 2 parts to 10 parts. Once dried, this amount corresponds to a weight ratio of about 10 parts polymer to about 1 part crosslinking agent, based on polymer solids.

The extent of crosslinking is critical to the absorbent properties of the compositions of the present innovation. At increased crosslinking agent concentrations, the polymer crosslinks to a greater extent increasing the total fluid holding capacity under load. Conversely, at low crosslinking agent concentrations, the total absorbent capacity under load is reduced. Further, the viscosity is critical to the ease of application. The cross-linked polymer absorbs about 50 to 150, and preferably about 100 times, its weight of the polymer in water. Under conditions of very low humidity, the crosslinked polymer may become sufficiently dehydrated such that the dried polymer film is friable. However, at atmospheric conditions, wherein the relative humidity ranges from 20% to 85%, the dried polymer is typically translucent and flexible due to its hydroscopic nature and propensity to be in equilibrium with the moisture content of its environment. In preferred embodiments, the crosslinked polymer absorbs at least about 5 weight percent, preferably at least about 10 weight percent and more preferably at least about 20 weight percent of moisture from the air at ambient temperature and about 50% relative humidity.

Curing is effective to obtain cross-linking of the soluble polymer. Before, after or during curing, a super absorbent polymer in particulate form may be blended with the soluble polymer and cross-linking agent.

The superabsorbent polymers of the present innovation are preferably cured at a temperature within the range of 40° F. to about 350° F.

The superabsorbent polymer compositions of the present innovation typically possess sufficient wet adhesion to adhere to the intended substrate. However, in embodiments wherein it is desirable to increase the adhesive and/or cohesive strength of the super absorbent polymer composition, the composition of the present innovation can be advantageously combined with compatible water based adhesives in either emulsion or dispersion form. Suitable water based adhesives include acrylics, vinyl acrylics, styrene acrylics, styrene butadiene rubber, vinyl acetate-versatic acid esters and vinyl acetate-ethylene. For such embodiments, the super absorbent composition may be combined with the water based adhesive emulsion/dispersion at ratios ranging from 95:5 to 5:95, preferably from about 20:1 to 5:1, and most preferably from about 1:1 to about 2:1.

The aqueous super absorbent polymer composition can be sprayed, foam coated, printed or saturated onto a surface or into a substrate. Depending on the amount of the super absorbent polymer applied, the coated surface is characterized by enhanced hydrophilicity and/or enhanced absorbency. To provide enhanced absorbency properties to the substrate or fibers, the amount of aqueous super absorbent polymer employed typically ranges from about 50 to about 200 weight percent and preferably from about 75 to about 150 weight percent of the total weight of the substrate or fibers coated.

Further, applying a sufficient amount of the aqueous super absorbent polymer composition to a web of fibers may form a self-supporting super absorbent web. The starting fiber layer or mass can be formed by any one of the conventional techniques for depositing or arranging fibers in a web or layer. Examples of these techniques include carding, garneting, air-laying and wet laying, which are well known to those skilled in the art. Individual webs or thin layers formed by one or more of these techniques can also be laminated to provide more loft and caliper. Typically, the fibers extend in a plurality of diverse directions in general alignment with the major plane of the fabric, overlapping, intersecting and supporting one another to form an open, porous structure.

The nonwoven web can be bonded with polymeric binders well known in the art, such as vinyl acetate/ethylene/N-methylolacrylamide copolymers, self-crosslinking acrylics and styrene-butadienes. The liquid absorbent composition may have sufficient adhesive qualities (wet and dry strength) alone for use as both the nonwoven binder and the absorbent material.

Thus, various polymeric binders known in the art can be used to prepare nonwoven products or fabrics by a variety of methods known in the art which, in general, involve the impregnation of a loosely assembled mass of fibers with the aqueous emulsion nonwoven binder, followed by moderate heating to coalesce the mass. This moderate heating also serves to cure the binder by forming a crosslinked interpolymer. Before being applied, the binder is mixed with a suitable catalyst to activate the crosslinking functional moieties on the polymer backbone. For example, an acid catalyst such as mineral acids (e.g., hydrogen chloride) or organic acids (e.g., oxalic acid) or acid salts such as ammonium chloride, can be used. The amount of catalyst is generally from 0.10% to 2% of the total polymer.

When used also as the polymeric binder, the super absorbent polymer composition is applied to the fibrous starting web in an amount sufficient to form a self-supporting web and provide enhanced absorbent properties. The concentration of super absorbent polymer suitably ranges from about 3 to about 100 weight percent preferably from about 10 to about 50 weight percent based on the starting web. The impregnated web is then dried and cured. Passing through one or more air dryers and then through a curing oven suitably dries the nonwoven products. Typical conditions of time and temperature are well known in the art. Where a separate polymeric binder is used to bond the nonwoven web, the absorbent polymer is applied to the bonded web in an amount sufficient to provide enhanced absorbent properties to the web and may range from about 5 to about 50 weight percent, preferably from about 10 to about 25 weight percent, based on the web.

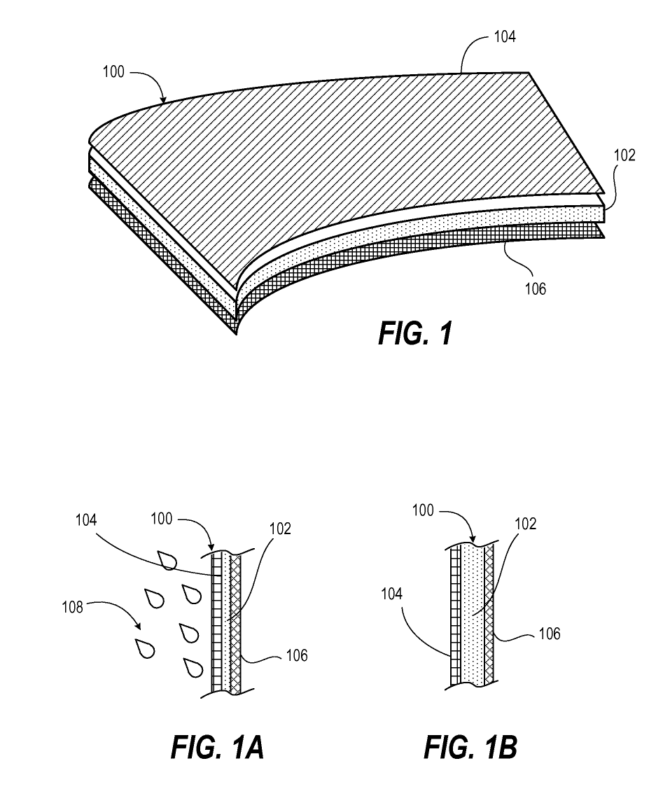

FIG. 1 illustrates a multi-use textile barrier apparatus 100 incorporating an aqueous super absorbent polymer (SAP) composition layer 102 between a top fabric layer 104 and a bottom fabric layer 106. At least one of the fabric layers 104, 106 is water permeable to allow water or water vapor to pass to the SAP composition layer 102, as depicted in FIG. 1A. Over a period of hours or days, the SAP composition layer 102 swells with water 108 as depicted in FIG. 1B. The water can advantageously provide a cooling effect, a source of moisture for vegetation, fire retardation, an impact absorbing surface, etc.

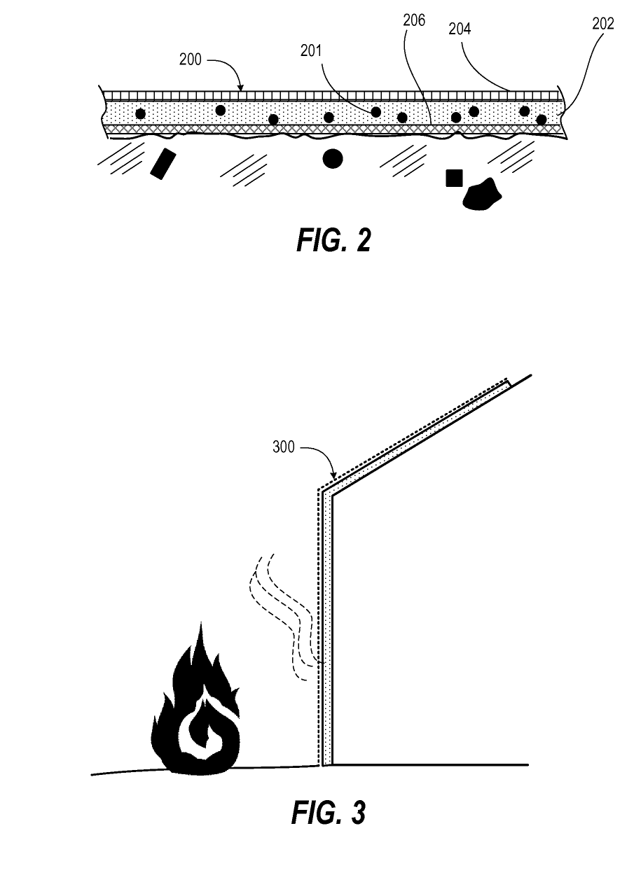

FIG. 2 illustrates a first example textile barrier apparatus 200 that includes an odor mitigating additive 201 for use as a landfill cover/blanket. One or more woven or nonwoven geotextile layers 204, 206 are impregnated with the composition of the present innovation in a continuous or patterned concentration. A SAP composition 202 can contain mitigating additives 201 such as odor neutralizers, biocides and nutrients to support vegetation. The composition in particulate form can be use individually or in combination with the textile barrier apparatus to produce a synergistic effect of the overall functionality.

In one or more embodiments, the present invention provides for a textile barrier apparatus 200 and a method of containing environmental toxicants on one side of a barrier article. In one or more embodiments, the method comprises placing the barrier article over an environmentally hazardous condition wherein the barrier article inhibits movement of environmental toxicants in the environmentally hazardous condition into the environment.

In one or more embodiments, the barrier article includes a substrate including one or more of a landfill liner, a landfill cap, a vertical subsurface containment barrier, a subsurface permeable reactive barrier, a vapor intrusion barrier, a tarp barrier, an RCRA cap and a continuous sealant layer adhered to the surface of the substrate or combinations therein, wherein the formed barrier layer is substantially impermeable to transmission of the environmental toxicants. In one embodiment, the substrate is a flexible sheet comprising polyethylene, polypropylene, polyethylene terephthalate, polyvinyl chloride, polyvinilydine chloride, acrylic, acetate, neoprene, or silicone rubber. In another embodiment, the barrier article of claim 1 wherein the substrate is a textile cotton, wool, polyester, nylon, Teflon, Gortex, glass, or fiberglass.

FIG. 3 illustrates a second example textile barrier apparatus 300 for use as a fire barrier textile for structure protection. One or more layers of woven and nonwoven geotextile impregnated with the composition of the present disclosure that swells to up to 3000× its weight when in contact with water. The system utilizes the high heat capacity of water to extinguish, create a barrier or direct fires in the open landscape and protect structures and dwellings. The geotextile can also be treated with other fire resistant chemicals and work synergistically with the composition. The blanket can also include nutrients to facilitate the establishment of vegetation after the fire threat is eliminated. Swaths of the fabric can be installed semi-permanently in the landscape or on a structure to create a chargeable fire barrier or be deployed during the time of a fire threat. The top layer of fabric can be printed with warnings related to the threat of fire or other unsafe conditions. The materials of the present invention are very useful for firefighting and for producing fire-retarding coatings. The materials of the present invention can be used for example for firefighting in forests, structures, tire warehouses, landfill sites, coal stocks, timberyards and mines. The materials of the present invention can be used for example for fighting forest fires from the air, for example by airplanes and helicopters.

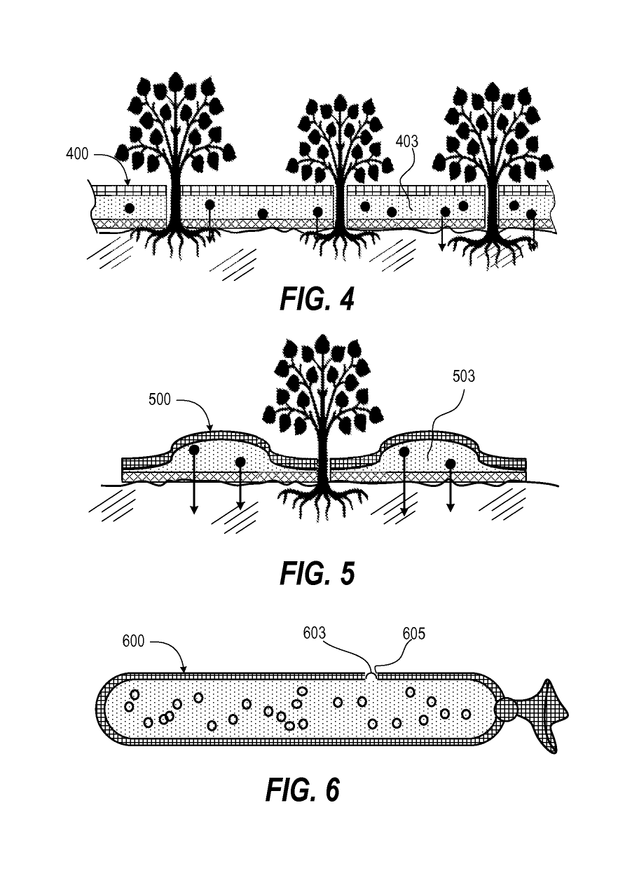

FIG. 4 illustrates a third example textile barrier apparatus 400 for use as a vegetation support ground cover textile. One or more layers of fabric are impregnated with the composition of the present innovation in aqueous and/or particulate form. The system can have continuous coating 403 or a patterned coating 503 of a barrier apparatus 500 of FIG. 5 that puts the composition in a place for best use by the plant. The ability to combine the aqueous and particulate compositions is unique and synergistic. Additives such as nutrients, fungicides, biocides, fragrances, etc. can be added to the composition. A fabric of various colors can be used and/or the composition can be pigmented. The top layer of the geotextile system can be printed with a diagram of location and names of specific plants to be used as a guide to grow vegetables or create a pleasing plant area for aesthetic purposes. The geotextile can also contain a text warning to stay off vulnerable plant propagation areas. The geotextile system can also be hung vertically for colorful displays of flowering plants and ground covers and can be used for banners, wall coverings, living billboards, etc.

FIG. 6 illustrates a fourth example barrier apparatus 600 for use as self-healing membrane. One or more layers of material such as rubber, polymers, geotextiles, or combinations thereof are used with the SAP composition 603 of the present innovation impregnated into one or more layers or sandwiched adjacent to one or more layers. The apparatus 600 is set up to constrict the swelling of the composition upon exposure to an aqueous material. This causes the composition to expand to fill a void 605 created by a puncture or tear and become substantially impermeable. The amount of composition and configuration of the fabric system can be programmed depending on end use. For example, if the self-healing membrane is to be deployed with natural pressure against the membrane from soil and/or water, then less composition is needed, and the internal constrictive qualities of the fabric system are less critical. In the case of a self-healing membrane that will be deployed and have no pressure on the membrane, the fabric system will need to hold layers in intimate contact by use of needle punching, binding, seaming, etc.

In one or more embodiments, the membrane barrier apparatus 600 for use as self-healing membrane wherein one or more layers of material such as rubber, polymers, geotextiles, or combinations thereof are used with the SAP composition 603 of the present innovation impregnated into one or more layers or sandwiched adjacent to one or more layers and wherein the superabsorbent polymer comprises a dry weight in reference to area ranging from 5 to 1500 g/m², preferably from 10 to 1000 g/m², more preferably from 25 to 500 g/m².

In one or more embodiments, the membrane barrier apparatus 600 for use as self-healing membrane wherein one or more layers of material such as rubber, polymers, geotextiles, or combinations thereof are used with the SAP composition 603 of the present innovation impregnated into one or more layers or sandwiched adjacent to one or more layers and wherein the superabsorbent polymer is capable of repeated use, chargeable with liquid and upon discharge showing a cooling effect.

In one or more embodiments, the self-healing membrane barrier apparatus 600 is embodied such that it can be connected, arranged at or insert into a piece of clothing or another object.

In one or more embodiments, the membrane barrier apparatus 600 comprises two or more layers, wherein at least one layer formed from a textile fabric. In one or more embodiments, the membrane barrier apparatus 600 is embodied as a textile material, functional textile, element with cooling functions, embodied such that it can be connected, arranged at or insert into a piece of clothing or another object particularly mentioned in the following: a piece of clothing, accessory, protective clothing, liner (fixed or detachable) for pieces of clothing (such as particularly jacket, suit, trousers, overall, apron), tarp, blanket, ceiling and/or roof structure, medical product, surgery blanket, pulse cooler, scarf, cooling tape, cooler bandage, suspender, foot and joint bandage, orthotic, facial mask, eye mask, stocking, pantyhose, head covering, helmet, shoe, or boot, cover, particularly vehicle, ship, airplane, building, machine, floor, surface, or equipment cover, awning, tent material, sun roof, covering and/or protective tarp, or equipment for protecting from high temperatures, bag, tote, blood bag, bottle or ampoule-cooling, drug protection bag, storage vessel for protection of biological or human components and/or substances and/or pharmaceutically effective agents, product, and/or substance from high temperatures, backpack and/or other sports or outdoor product, sports jersey, sports attire, underwear, storage, transportation, animal cooling product or the like.

In one embodiment, the barrier is a flexible, self-healing membrane for use in roofing applications wherein the roof structure is provided with a self-healing membrane in order to render it watertight. Roofing membranes are commonly made of various synthetic rubber materials, modified bitumen, or thermoplastic materials. A common type of roofing membrane is a thermoplastic polyolefin or TPO membrane. In one embodiment, the roof comprises a flat membrane roof. In another embodiment, the roof comprises a low-maintenance and green roof system. In another embodiment, the roof comprises a sloped roofing.

In one embodiment at least a portion of the membrane and/or at least one layer comprises a material that is liquid-tight, spark or flame-resistant, repellant against liquid metal and/or resistant against metal or ember sparks, liquid tight, self-cleaning, dirt-repelling, biocidal, antimicrobial, antiviral, antibacterial, antibiotic, UV-blocking, repellant, cosmetically and/or medically effective, hydrophilizing, or absorbing or shielding electromagnetic radiation and/or being rubber-like, or comprises a coating, finishing or activation that is fire, spark, or flame-resistant, repellant against liquid metal and/or resistant against metal or ember sparks, liquid tight, self-cleaning, dirt-repellant, biocidal, antimicrobial, antiviral, antibacterial, antibiotic, UV-blocking, repellant, cosmetically and/or medically effective, hydrophilizing, or absorbing or shielding electromagnetic radiation, and/or being rubber-like.

In one embodiment, at least one layer comprises an additional activation, particularly a coating, finishing, and/or activation that is liquid-tight, flame-resistant, fire-resistant, spark-resistant, repellant against metal or ember sparks, resistant to liquid metal, self-cleaning, dirt-repellant, biocidal, antiviral, UV-blocking, antistatic, repellant, cosmetically effective, medically effective, hydrophilizing, antimicrobial, antibacterial, antibiotic, and/or absorbing or shielding electromagnetic radiation. In one embodiment, the present invention provides for a roofing membrane that is a laminate comprising an outer layer of a cured polymeric film comprising a non-halogenated fire retardant component, the fire retardant component being from greater than about 5% to about 95% of the outer layer by weight and a polymeric film underlayer, wherein one or more layers of material such as rubber, polymers, geotextiles, or combinations thereof are used with the SAP composition 603 of the present innovation impregnated into one or more layers or sandwiched adjacent to one or more layers and wherein the superabsorbent polymer comprises a dry weight in reference to area ranging from 5 to 1500 g/m², preferably from 10 to 1000 g/m², more preferably from 25 to 500 g/m². In another embodiment of the present invention, a method for protecting a roof surface substrate from fire damage is provided that comprises providing the roofing membrane as described herein, and applying the roofing membrane to a roof surface substrate with the polymeric film underlayer being in contact with the roof surface substrate. This orientation of the roofing membrane on the roof structure provides enhanced protection of the roof from floating embers or the like that could cause a fire originating from outside of the building.

In this connection the invention also provides a cooling roof construction comprising a roof membrane having a membrane further comprising a layer of superabsorbent polymer.

Single and multi-layer building membranes may be used as roofing or facade films. In on or more embodiments, this comprises a layer of a textile, geotextile, polymer, rubber-elastic or thermoplastic material modified with a softener, whereby the former is referred to as “rubber film” in the industry and typically has pores, for example. Needle-punching the rubber film can generate these pores. Such rubber films are constructed to be open to contact by the SAP to moisture or water so that the SAP releases the water over a period of time to cool the roof. The roof structure may include a waterproof membrane for the roof while maintaining a non-waterproof surface facing the environment such that water may be introduced to the system for cooling while maintaining waterproof qualities for the structure. The membrane therefore proves for vapor diffusion openness, as well as for water impermeability.

In one or more embodiments, the membrane is embodied at least partially permeably and pores are provided for the penetration of liquids and/or gas, particularly water, alcohol, and/or water/alcohol vapor or mixtures thereof, with the pore size being embodied smaller than the diameter of the SAP particles contained therein.

In one embodiment, a sensor is provided for detecting the exterior temperature and/or the cover temperature, particularly with a temperature display being allocated to the sensor and/or that the sensor is embodied in the form of a color-changing coating or a thermometer and/or that at least one sensor being provided to detect climatic factors in the environment of the cooling system, particularly to detect the ambient temperatures, relative humidity, and/or air flow.

In one embodiment, the SAP membrane cooling system is for the use within the scope of a controlled or monitored cooling of people, animals and/or objects comprising a cover according to the present invention. In another embodiment, the SAP membrane cooling system further comprises a source of water or other moisture for charging the SAP with hydration.

In this connection the invention also provides a fire-retardant roofing membrane comprising a first and second membrane layer with a layer of superabsorbent polymer situated between layers. In a further embodiment, the roofing membrane further comprises one or more fire-retardant or fire-extinguishing additives, such as magnesium hydroxide, aluminum tri-hydrate, and the like.

In one embodiment, the barrier is a flexible, self-healing membrane for use as a dust and/or odor controlling membrane comprising a first and second membrane layer with a layer of superabsorbent polymer situated between layers. In a further embodiment, the self-healing membrane membrane further comprises one or more dust and/or odor controlling additives.

In another embodiment, the superabsorbent polymers are used in a particulate, fibrous, granular or powder form in order to form an active barrier. In one or more embodiments, a barrier is created using superabsorbent polymer in a particulate, fibrous, granular or powder form (as used herein “particle” or “particulate”) in order to form an active barrier wherein the particulates further comprise a performance-enhancing active or performance-enhancing additive. Such particulate barriers can be used for odor control, dust control, plant growth or combinations thereof.

In another embodiment, the superabsorbent polymers are used in a particulate, fibrous, granular or powder form in order to form an active barrier comprising application of the particulates onto a surface to a depth of from 0.1″ to 5″, preferably to a depth of from 0.1″ to 3″, more preferably to a depth to at least 0.25 for any surface application and at least 2″ for below surface application.

In one or more embodiments, the particulates may have a diameter of 0.1 to 36 mm. In other embodiments, the particulates may have a diameter of 0.5 to 12 mm. In other embodiments, the particulates may have a diameter of 0.5 to 5 mm.

In other embodiments, the method is characterized in that granulates with a mean diameter of 0.1 to 20 mm, preferably 0.5 to 10 mm, particularly preferably 1 to 5 mm can be produced in this manner. The morphology and particle size of the granulates thus depends on the type and quantity of the additive or additives and on the type and intensity of the mixing or mixing equipment. The composition of the materials as well as the particle size of the additive may also have an influence. Preferably, by judicious selection of the type and quantity of the additives, a suitable granulate size is obtained. These inter-relationships can be determined for the respective composition of the moist materials in question by simple routine mixing tests. Particularly preferably, granulates with a mean dimension of 0.5 to 10 mm, in particular 1 to 5 mm are manufactured, with subsequent drying, whereby the mechanical load on the granulates is only small. In this manner, dust removal on drying can be completely dispensed with, or a simple and inexpensive method for dust removal can be selected (for example a cyclone or wet scrubber). Preferably, the superabsorbent is or comprises a polymerizate of acrylic acid.

In one embodiment, the particulate is used to control the release or contact with an agent or agents such as detergents, abrasives, waxes, polishes, drugs, cosmetics, biologicals, volatiles, odor control compositions, polyoxometalates (POMS) and chemicals or optionally and selectively other additives when such particulate product composite is brought into contact with water or an aqueous effluent during application and use of the granular sized particulate product.

In one embodiment, the layer of water-absorbing particulate material is provided to a surface of treatment to a thickness that is substantially within the range of about 1 mm to about 60 mm, preferably within a range of about 3 mm to about 60 mm, more preferably within a range of about 5 mm to about 60 mm and more preferably within a range of about 10 mm to about 40 mm. In one embodiment, the layer of water-absorbing particulate material is provided to a surface for odor control. In one embodiment, the layer of water-absorbing particulate material is provided to a surface for dust control. In one embodiment, the layer of water-absorbing particulate material is provided to a surface for nutrient support of vegetation. In one embodiment, the layer of water-absorbing particulate material is provided to a surface for bioremediation. In one or more embodiments, the particulates are used in conjunction with one or more of the barriers listed above.

During polymerization, water soluble agents and the selected additives are incorporated homogenously into the structure of the granulated or sized SAP particulates of the formed compositions or products. These agents and additives, if any, remain bound in position in until the granulated or sized particulate of the formed composition or products are wetted or contacted by sufficient moisture to activate the agents in the granules or sized particles of such formed compositions or products, at which time one or more of the agents and such additives, if any, present are slowly released from the structure of the formed granulated or sized particulate compositions or product and diffuse toward the surface, where they can be put to use for cleaning, scrubbing, waxing, polishing, controlling noxious odors, as the case may be, for a given agent or agents and the selected additive, if any, for a given application or use.

In one or more embodiments, the SAP particulates are used in at least one of an animal litter product, a laundry product, a home care product, a water filtration product, an air filtration product, a fertilizer product, an iron ore pelletizing product, a pharmaceutical product, an agricultural product, a waste and landfill remediation product, a bioremediation product, and an insecticide product. Such applications can utilize the aforementioned unit operations like pan agglomeration and the novel process technologies described here to deliver smart time-releasing actives or other types of actives and ingredients in a strategic manner. The targeted active delivery approach delivers benefits that include but should not be limited to the cost efficient use of actives, improvements in active performance, timely activation of actives where needed, and improvements in the consumer perceivable color of the active in the final product. One can strategically choose combinations of ingredients and targeted active delivery methods to maximize the performance of actives in final products such as those described here. Absorbents with actives specifically chosen to attack a particular waste material could be engineered using the technology described herein. Exemplary waste materials include toxic waste, organic waste, hazardous waste, and non-toxic waste.

In one or more embodiments, the particulates comprise a core or substrate upon which the SAP is coated. “Substrate” as used herein, refers to any surface upon which it is desirable to deposit a coating comprising a polymer, a mix of polymers or water-absorbing materials. In the present invention, the substrate is generally made up of fine granules of stone, gravel, sand, asphalt, cement, ceramic beads, soil, clay, diatomaceous earth, perlite, silica, organic minerals, rubber or combinations thereof.

In another embodiment, the water-absorbing material “surrounds” a core or substrate (e.g., sand, ground rubber, powder, granules, clumps, etc.) forming a water-absorbing particle. In one embodiment, a coupling agent or binder is used between the substrate (e.g., rubber particles, silica sand grains, etc.) and the water-absorbing material coating material. Such binders are characterized by having an improved adherence to the surface of the core as well as to the water absorbing coating material as compared to the adherence between the coating material and the core surface when being in direct contact. The hinders may be used alone or in a combination of two or more thereof. In one embodiment, the binding agent is a silane. In another embodiment, the silane is one or more organosilozane, silane monomer, or mixtures thereof.

In another embodiment, the core comprises a polymer material. In another embodiment, the core comprises a rubber material. In another embodiment, the core comprises SBR crumb rubber. The resilient, particles and the particles of water-absorbing material coated granular material have a median size that is within a range of about 5 to about 60 mesh. More preferably, both types of particles have a median size that is substantially within a range of about 10 to about 45 mesh.

In another embodiment, the particulate core consists of SBR crumb rubber sourced from passenger car and small truck tires. The rubber can be either ground under ambient or cryogenic conditions. The particle size of the rubber can vary between 6 and 50 mesh. A desirable particle size range is from 10 to 20 mesh. the SAP can be most advantageously introduced as a thin coating of SAP on the sand particles. The same method of coating the particle with a water solution of a pre-polymer of polyacrylic acid with a cross-linker can be used to coat silica sand. The water solution is blended with the sand to wet out the surface of the sand. The water is allowed to evaporate and drive the cross-linking reaction.

The integrity of the SAP and the adhesion of the SAP to the sand particle surface can be enhanced by using a binder. The binder should contain silane groups that will have affinity for the silica sand surface as well as hydroxyl or carboxyl groups to react with the titanium carbonate cross-linker.

In another embodiment, the particles of water-absorbing material coated granular material are fabricated so that the water-absorbing material coating comprises about 0.2% to about 10% by weight of core of granular material. In another embodiment, the water-absorbing material coating comprises about 0.4% to about 5.0% by weight of the core of granular material. In another embodiment, the water-absorbing material coating comprises about 0.6% to about 3.0% by weight of the core of granular material.

The core of granular material is preferably quartz sand and is preferably of an overall grain diameter in the range of about (nom inches to about 0.2 inches, and in another embodiment, in the range of about 0.001 inches to about 0.1 inches, and most preferably in the range of about 0.015 inches to about 0.07 inches.

In some embodiments of the invention, a lightweight or heavyweight core material can be used to import differing performance characteristics. The core can be solid, hollow, absorbent, nonabsorbent, and combinations of these. In some embodiments of the invention, lightweight core materials include but are not limited to calcium bentonite clay, attapulgite clay, perlite, silica, non-absorbent silicious materials, sand, plant seeds, polymeric materials, ground rubber and mixtures thereof. In some embodiments of the invention, heavyweight cores may be used when it is desirable to have heavier particles.

In one embodiment, water-absorbing materials may be used as the core of the particle without departing from the spirit and scope of the present invention. Illustrative absorbent materials include but are not limited to minerals, fly ash, absorbing pelletized materials, perlite, silicas, other absorbent materials and mixtures thereof. In one embodiment, minerals include: bentonites, zeolites, fullers earth, attapulgite, montmorillonite diatomaceous earth, opaline silica, crystalline silica, silica gel, alumina, Georgia White clay, sepiolite, calcite, dolomite, slate, pumice, tobermite, marls, attapulgite, kaolinite, halloysite, smectite, vermiculite, hectorite, Fuller's earth, fossilized plant materials, expanded perlites, gypsum and other similar minerals and mixtures thereof.

A suitable superabsorbent polymer may be selected, from natural, biodegradable, synthetic and modified natural polymers and materials. Superabsorbent polymers include internal cross-linking. The superabsorbent polymer composition may include surface treatment of the superabsorbent polymer as set forth herein.

“Additive” or “Performance-enhancing additive” as used herein, refers to any active or additive which is desirable to add to the infill particles including an antimicrobial, an odor reducing material, a binder, a fragrance, a color altering agent, a dust reducing agent, a nonstick release agent, a superabsorbent material, cyclodextrin, zeolite, activated carbon, a pH altering agent, a salt forming material, a ricinoleate, silica gel, UV stabilizers or protectants, crystalline silica, activated alumina, an anti-clumping agent, and mixtures thereof. Performance-enhancing actives that inhibit the formation of odor include a water-soluble metal salt such as silver, copper, zinc, iron, and aluminum salts and mixtures thereof.

In one or more embodiments, the formed particulate barrier comprises from about 0.25 to about 5 pounds of SAP particulate material per square foot mixed with a 2-8 inch sand profile. In one or more embodiments, the surface comprises from about 0.5-3 pounds of SAP particulate material per square foot mixed with a 3-6 inch sand profile. In one or more embodiments, the surface comprises from about 0.5-2 pounds of SAP particulate material per square foot mixed with a 3-6 inch sand profile. Typical size of an arena is 16,000 square feet.

The SAP particulate materials may include one or more of the following: colorants, such as dyes or pigments; an oil or oil-like material (water soluble, water insoluble, or a polymeric composition) that enhances the appearance, fragrance, longevity, and/or insect repellency of the SAP particulate material; insecticides (e.g., DEET); fungicides; herbicides; fertilizers; nutrients; dust control agents; odor control agents; sunscreening agents; UV reactive curing agents, coatings, hardeners, binders, paints or pigments (e.g., UV cured monomer resins, especially for application to rubber or sand, including PMPTA); seed; erosion control materials (such as, for example, naturally derived vegetable binders); plant aging or plant decomposition accelerating materials; luminescent, fluorescent, or phosphorescent pigments or other reflective compounds or minerals; binding agents (both polymeric and non-polymeric for adhering the SAP particulate materials together); wetting agents; polymeric materials (such as acrylic polymers) for anti-weathering and appearance enhancing; polyethylene polymers for providing a gloss; concrete sealers; water repellants or preservatives; and wood preservatives, protectors or sealants.

In one embodiment, the SAP particulate material comprises a flame retardant and fire extinguishing product for preventing and fighting fires. In one or more embodiments, the particulate material comprises one or more of water, flame retardants or mixtures thereof. In one embodiment, the flame retardant comprises one or more ammonium salts, one or more nitrogen-containing compounds, one or more phosphates, or one or more sulfates or combinations thereof. In one embodiment, the flame retardant comprises between 3% and 25% of the product.

The materials of the present invention are very useful for firefighting and for producing fire-retarding coatings. The materials of the present invention can be used for example for firefighting in forests, structures, tire warehouses, landfill sites, coal stocks, timberyards and mines. The materials of the present invention can be used for example for fighting forest fires from the air, for example by airplanes and helicopters. In one embodiment, the product prevents ignition or re-ignition of flamable material by forming a layer of protection against ignition or re-ignition. In one embodiment, the product is used to fight forest fires or other wildfires. In one embodiment, the product is used to create fire breaks without requiring excavation or tree removal. In one embodiment, the product is used in light or heavy ground-based firefighting equipment or in aerial firefighting equipment.

In one embodiment, the SAP particulate material comprises a colorant. The colorant may be, for example, a dye or a pigment. The dye may be dry, in liquid form, or dissolved in a liquid carrier. The pigment may be dry, suspended in a liquid carrier or carried on a substrate such as polymer or glass beads. Further, the pigments may be in powder, pellet or granule form.

The dyes and pigments may be natural or synthetic. Preferred pigments include various iron oxides, carbon, and titanium dioxide. Other colorants that may be used include tannins, vegetable tints, other natural colorants derived from plants, synthetic dyes, food colorings, and the like. Preferably, the colorants are non-toxic. A colorant may be used individually or blended with another colorant to obtain any desired color.

In one or more embodiments where the SAP particulate materials to be colored, the treatment for the SAP particulate material may comprise a pigment and a binder. In one embodiment, the binder is an acrylic polymer system. In one embodiment, the binder is a silicate binder, although other binders could be used such as silicone or certain clays, e.g., kaolin or bentonite or a polymer binder system such as vinyl acetate, acrylics, styrene acrylics, co-polymer vinyl, polyacrylates, urethanes, methylcellulose, liginsulphonatc, polyvinyl alcohol, polyethylene wax emulsions, or mixtures therein.

In some embodiments, the composition may further include an odor control agent, such as, e.g., an odor masking agent or an odor neutralizing agent. In some embodiments, the odor control agent may include the ECOSORB® line of odor control additives (available from OMI Industries, Long Grove, Ill.), vanillin, C1-C20 esters, acidic compounds, acidic resins, ion-exchange resins, adsorbent resins, and/or activated charcoal. In some embodiments, the odor control agent may include an ECOSORB® additive and/or vanillin. Additionally, in some embodiments, the odor control agent may include the Lemon QuikAir product line (e.g., Lemon QuikAir, LemonQuikAir 1, Lemon QuikAir 2 and Lemon QuikAir 3), the QuickSoil Product line (e.g., QuickSoil 2300, QuickSoil 2400 and QuickSoil 2800), GOC 901 MC, GOC 501 MC and QuikAir 900, all of which available from GOC Technologies, Inc. (East Sussex, United Kingdom). Some additional nonlimiting examples of suitable odor control agents include citric acid, amyl acetate, .alpha-amylcinnamaldehyde, linalyl acetate, 5-methylfurfural and 2-ethylhexanal.

In another embodiment, the SAP particulate material comprises at least one oil (or oil-like) material that will enhance the appearance, fragrance and/or insect or animal repellency of the SAP particulate material. The oil material may include one or more natural oils (plant derived or animal derived oils or their component fractions), one or more synthetic oils (including mineral oils and silicones), esters, chemical derivatives of any of the foregoing, or a combination thereof. The oil materials may additionally provide a benefit of dust suppression. Additionally the oils may be tinted.

The plant-derived natural oils may be, for example, neem oil, karanja oil, citronella oil, citrus oils, cinnamon oil (bark and leaf), eucalyptus oil, cedar oil, lemongrass oil, linseed oil, soybean oil, licorice oil, clove oil, mint oil, sweet birch oil, spearmint oil, peppermint oil, anise oil, bergamot oil, canola oil, castor oil, cedarwood oil, jojoba oil, lavandin oil, mustard seed oil, coconut oil, eue oil, tulsi oil, almond oil, cottonseed oil, corn oil, geranium oil, sesame oil, thyme oil, tung oil, rosemary oil, basil oil, fennel oil, ginger oil, grapefruit oil, mandarin oil, orange oil, pepper oil, rose oil, tangerine oil, tea tree oil, tea seed oil, balsam oil, bay oil, capsicum oil, caraway oil, cardamom oil, cassia oil, celery oil, cognac oil, dillweed oil, guaiacwood oil, juniper berry oil, lime oil, origanum oil, parsley oil, pimento leaf oil, a jowan oil, apricot oil, betel leaf oil, bawchi oil, chilly seed oil, clary sage oil, cubeb oil, curry leaf oil, frankincense oil, ginger grass oil, gulthria oil, heeng oil, jamrosa oil, kulanjan oil, kalaunji oil, linaloe berry oil, ban tulasi oil, bursera oil, cumin seed oil, cyperiol oil, gereniol oil, grape seed oil, hinoki oil, juniper leaf oil, laurel berry oil, lichen oil, mace oil, mango ginger oil, mentha pipereta oil, paparika oil, vetivert oil, wheat germ oil, watermelon oil, macassar oil, mentha citreta oil, musk melon oil, nar kachur oil, palmarosa oil, patchouli oil, perilla seed oil, pomegranite oil, pumpkin oil, tomar seed oil, cananga oil, herbal puja oil, avocado oil, safflower oil, abies alba needle oil, ambrette seed oil, amyris oil angelica root oil, artemisia oil, estragon oil, fir needle oil, galangal oil, galbanum oil, olibanum oil, palmarosa oil, patchouli oil, birch oil, cajeput oil, calamus oil, cananga oil, carrot oil, cistus oil, citron oil, coriander oil, costus oil, cypress oil, davana oil, dill wood oil, dwarf pine needle oil, elemi oil, guajac oil, hop oil, hyssop oil, chamomile, jasmine oil, larch oil, laurel leaf oil, lavender oil, lemon balm oil, limba pine oil, litsea cubeba oil, lovage oil, manuca oil, marjoran oil, milfoil oil, myrrh oil, myrtle oil, neroli oil, niauli oil, petit grain oil, rockrose oil, rosewood oil, sage oil, rue oil, sassafras oil, spik oil, tagetes oil, thuja oil, valerian oil, verbena oil, vervain oil, vetiver oil, wintergreen oil, wormwood oil, ylang ylang oil, olive oil, evening primrose oil, hazelnut oil, grape core oil, peach core oil, walnut oil, sunflower oil, sandalwood oil, tumeric oil, nutmeg oil, soy oil, vegetable oils, menthol oil, eucalyptol, camphor oil, cedar leaf oil, pine oil, red pine oil, or combinations thereof.

Potentially employable animal derived natural oils may include, for example, tallow oil or fish derived oil (e.g., cod liver oil or shark oil) and their component fractions.

One or more synthetic oils, including mineral oils, silicones and fatty acid esters, and their chemical derivatives, preferably non-toxic, may be used in lieu of or in combination with one or more of the natural oils. Examples of mineral oils include, for example, petroleum derived oils. The fatty acid esters, such as alkyl stearate, are formed by the combination of a medium to long chain alcohol with a suitable long chain fatty acid, which may be branched or unbranched.

In addition to natural oils, which may impart a fragrance to the SAP particulate material, synthetic fragrance-imparting oils may be included in the SAP particulate materials including, for example, acetophenone, C10-C20 aldehydes, allyl cyclohexyl propionate, ambroxan, amyl cinnamic aldehyde, amyl salicylate, anisaldehyde, aurantiol, benzaldehyde, benzyl acetate, benzyl salicylate, brahmanol, calone, cashmeran, cedramber, cedryl acetate, cinnamic alcohol, citral, citronellal, citronellol, citronellyl acetate, coumarin, cyclamen aldehyde, cyclopentadecanolide, damascone beta, dihydromyrcenol, dimethyl benzyl carbinyl acetate, diphenyl oxide, ethyl phenylacetate, ethyl vanillin, eugenol, evemyl, frambinone, galaxolide gamma-decalactone, geraniol, geranyl acetate, geranyl formate, geranyl nitrile, geranyl acetate, hedione, helional, heliotropin, cis-3-hexenyl acetate, cis-3-hexenyl salicylate, hexyl cinnamic aldehyde, hexyl salicylate, hivertal, hydroxycitronellal, indol, ionone alpha, isobomyl acetate, isobutyl quinoline, isoeugenol, iso E super, isogalbanate, cis-jasmone, lilial, linalool, linalyl acetate, lyral, maltol, methyl anthranilate, methyl benzoate, methyl cinnamate, methyl chavicol, methyl ionone gamma, methyl napthyl ketone, methyl octine carbonate, methyl salicylate, musk ketone, musk T, paracresyl acetate, phenoxyethyl isobutyrate, phenylacetaldehyde, phenylacetic acid, phenylacetaldehyde dimethyl acetal, phenylethyl acetate, phenylethyl alcohol, phenylethyl dimethyl carbinol, phenylethyl phenylacetate, phenylpropyl alcohol, rosalva, rosatol, rose oxide, sandela, styrallyl acetate, terpineol, tonalid, vanillin, vertacetal, vertofix, vetiveryl acetate, vertenex (PTBCHA), and combinations thereof.

In one embodiment, the SAP particulate material comprises an oil material that will provide a pleasant scent to the SAP particulate materials. A single oil or a variety of combinations of oils may be employed to arrive at a desired scent. Preferably, the treatment includes an effective amount of individual oils or combinations of oils sufficient to enhance the aroma of the SAP particulate material being treated. The oils used in the treatment may release a scent for several months. Preferably, an amount of aroma-imparting oil or combination of oils effective to maintain a release of the desired scent for at least one month is employed. The oil materials may be supported on a substrate facilitating a timed-release or controlled-release of the oil material, such as polymer or glass beads, for example. Preferably, the beads are of sufficiently small size (approaching the size of colorant pigments) that they may be adequately distributed by foam. In an exemplary embodiment, a concentrated solution containing up to 40 percent by weight of an oil material and 60 percent by weight of a combination of surfactant and water, the combination of water and surfactant containing as much as 60 percent actives, may be employed. Depending upon the amount of treatment desired on the SAP particulate material (or desired effect of the treatment) and the throughput of the SAP particulate material being treated (e.g., the flow rate of the SAP particulate material through a SAP particulate material processing machine, such as a trommel device), the concentrated solution may be diluted down to a level that still facilitates foaming of the diluted solution onto the SAP particulate material.

Synthetic and/or natural oils may be employed which have a wide range of different scents, including, for example, apple, cinnamon, pine, strawberry, blueberry, and citrus scents. In one embodiment, the natural and/or synthetic oils will enhance the natural aroma or the perceived natural aroma of various types of wood, and may include, for example, such oils as vetivert, sandalwood oil, cedar oil, patchouli, rosewood oil, pine oil, cypress oil, birch oil, agar, wormwood oil, oakwood oil, vanillin, isobomyl acetate, fir balsam oil, and combinations thereof.

Plant extracts, including, for example, root extracts, herbal extracts, and bean extracts, such as vanilla extract, may further be included in the SAP particulate material in order to provide a desired aroma. Plant extracts may also be effective in repelling or killing insects. One plant extract, which may be included in the SAP particulate material is limonene, an extract from citrus plants, which is not only highly effective in repelling and killing insects, but also is environmentally safe.

Although the SAP particulate material may include a single oil, preferably a combination of oils is employed in an effective amount to provide each of an appearance enhancer, an insect repellant and a fragrance. One oil may provide one or more of these characteristics. Neem oil, citronella oil, karanga oil and nepetalactone oil are examples of some preferred oils, as they are especially effective oils in repelling insects.

In the case of water insoluble treatments for SAP particulate material, such as the above described oil materials, the treatment may be emulsified or carried by a substrate such as polymer or glass beads. Further, the oils may be solubilized in a solvent, such as water, via a solubilizer.

The SAP particulate material may additionally or alternatively comprise a luminescent, phosphorescent or fluorescent pigment or other reflective material for providing the SAP particulate material with a glittering, shimmering or light-reflecting appearance. Examples of such pigments or other materials include mica, nacreous pigments, aluminum flakes, glass flakes, paint flakes or chips, glass beads and molybdenum disulfide. The mica (such as pearl mica) or other materials may also include layers of titanium oxide, iron oxides, silver, gold, copper, palladium, nickel and cobalt, metal alloys, or combinations thereof, which may provide a colored appearance to the reflective pigment.

The SAP particulate material may additionally or alternatively comprise odor control agents. Such odor control agents may include commercially available materials such as SUPPRESS® manufactured by Westbridge Agricultural Products of Vista, Calif.

The SAP particulate material composition may also include one or more binders. Such binders may include, for example, any of a wide variety of commercial materials, which may be acrylic, vinyl acetate or other polymer systems.

In one embodiment, the performance-enhancing additive is sprayed onto the particles. In another embodiment, the performance-enhancing additives are dry-blended with the particles. In another embodiment the performance enhancing additive is blended with an elastomeric material than ground into particles.

The super absorbent polymer particles may further be treated with one or more antimicrobial agents, one or more anti-freezing agents, or a combination thereof.

In one embodiment, performance-enhancing additive(s) are added to the particles. In one embodiment, the performance-enhancing additive(s) are antimicrobials. In one embodiment, the antimicrobial actives are boron containing compounds such as borax pentahydrate, borax decahydrate, boric acid, polyborate, tetraboric acid, sodium metaborate, anhydrous, boron components of polymers, and mixtures thereof.

In one embodiment, the odor absorbing/inhibiting active inhibits the formation of odors. An illustrative material is a water-soluble metal salt such as silver, copper, zinc, iron, and aluminum salts and mixtures thereof. In another embodiment, the metallic salts are zinc chloride, zinc gluconate, zinc lactate, zinc maleate, zinc salicylate, zinc sulfate, zinc ricinoleate, copper chloride, copper gluconate, and mixtures thereof. In another embodiment, the odor control actives include nanoparticles that may be composed of many different materials such as carbon, metals, metal halides or oxides, or other materials. Additional types of odor absorbing/inhibiting actives include cyclodextrin, zeolites, silicas, activated carbon (also known as activated charcoal), acidic, salt-forming materials, and mixtures thereof. Activated alumina (Al₂O₃) has been found to provide odor control comparable and even superior to other odor control additives such as activated carbon, zeolites, and silica gel. Alumina is a white granular material, and is also called aluminum oxide.

In some aspects, additional additives may optionally be employed with the particulate superabsorbent polymer compositions, including odor-binding substances, such as cyclodextrins, zeolites, inorganic or organic salts, and similar materials; anti-caking additives, flow modification agents, surfactants, viscosity modifiers, and the like. In addition, additives may be employed that perform several roles during modifications. For example, a single additive may be a surfactant, viscosity modifier, and may react to cross-link polymer chains.

In another embodiment, a color altering agent such as a dye, pigmented polymer, metallic paint, bleach, lightener, etc. may be added to vary the color of absorbent particles, such as to darken or lighten the color of all or parts of the composition so it is more appealing. In another embodiment, the color-altering agent comprises up to approximately 20% of the absorbent composition, more preferably, 0.001%-5% of the composition. In another embodiment, the color altering agent comprises approximately 0.001%-0.1% of the composition.

In another embodiment, the carriers for the color-altering agent are zeolites, carbon, charcoal, etc. These substrates can be dyed, painted, coated with powdered colorant, etc.

In another embodiment, the activated alumina and activated carbon may include an embedded coloring agent that has been added during the fabrication of the activated alumina or activated carbon to form a colored particle.

In composite and other particles, the activated alumina can also be added in an amount sufficient to lighten or otherwise alter the overall color of the particle or the overall color of the entire composition.

Large particles of carbon, e.g., activated carbon or charcoal, can also be used as a darkening agent. Such particles are preferably within a particle diameter size range of about 0.01 to 10 times the mean diameter of the other particles in the mixture.

In another embodiment, the core mentioned above can also be considered an active, for example including a lightweight material in the core to reduce the weight of the particle, a core made of pH-altering material, etc.

It must be noted that, as used in this specification and the appended claims, the singular forms “a,” “an” and “the” include plural referents unless the content clearly dictates otherwise. Thus, for example, reference to a “colorant agent” includes two or more such agents.

Unless defined otherwise, all technical and scientific terms used herein have the same meaning as commonly understood by one of ordinary skill in the art to which the invention pertains. Although a number of methods and materials similar or equivalent to those described herein can be used in the practice of the present invention, the preferred materials and methods are described herein.

As will be appreciated by one having ordinary skill in the art, the methods and compositions of the invention substantially reduce or eliminate the disadvantages and drawbacks associated with prior art methods and compositions.

It should be noted that, when employed in the present disclosure, the terms “comprises,” “comprising,” and other derivatives from the root term “comprise” are intended to be open-ended terms that specify the presence of any stated features, elements, integers, steps, or components, and are not intended to preclude the presence or addition of one or more other features, elements, integers, steps, components, or groups thereof.

As required, detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure.

While it is apparent that the illustrative embodiments of the invention herein disclosed fulfill the objectives stated above, it will be appreciated that numerous modifications and other embodiments may be devised by one of ordinary skill in the art. Accordingly, it will be understood that the appended claims are intended to cover all such modifications and embodiments, which come within the spirit and scope of the present invention.

What is claimed is:

1. A textile barrier apparatus comprising:
an inner layer comprising an aqueous super absorbent polymer composition; and
first and second outer textile layers attached to opposite sides of the inner layer.

2. The textile barrier apparatus of claim 1, wherein the aqueous super absorbent polymer composition comprises a selected one or more of an odor neutralizer, a biocide and a nutrient to support vegetation.

3. The textile barrier apparatus of claim 1, wherein:
at least one of the first and second outer textile layers comprises a water permeable membrane; and
the first and second outer textile layers further comprise a fire retardant treatment.

4. The textile barrier apparatus of claim 1, wherein the aqueous super absorbent polymer composition comprises a patterned thickness corresponding to a planting pattern.

5. The textile barrier apparatus of claim 4, wherein the aqueous super absorbent polymer composition further comprises a nutrient to support vegetation.

6. A superabsorbent barrier for a surface, comprising a particulate form of a superabsorbent polymer wherein the particulates further comprise a performance-enhancing additive in order to form an active barrier on the surface.

7. The barrier of claim 6, wherein the performance-enhancing additive is for odor control, dust control, plant growth or combinations thereof.

8. The barrier of claim 6, wherein the particulates have a mean diameter of 0.1 to 20 mm.
